(19) United States
(12) Patent Application Publication
(10) Pub. No.: US 2023/0145110 A1
(43) Pub. Date: May 11, 2023

(54) METHOD OF MITIGATING THE IMPACT OF CARBON EMISSIONS FROM INVESTMENT ACTIVITY

(71) Applicant: RangeEagle Strategies, LLC, Valhalla, NY (US)

(72) Inventor: John PILEGGI, The Villages, FL (US)

(73) Assignee: RangeEagle Strategies, LLC, Valhalla, NY (US)

(21) Appl. No.: 17/520,079

(22) Filed: Nov. 5, 2021

(51) Int. Cl. G06Q 40/06; G06Q 40/04

(52) U.S. Cl. CPC G06Q 40/06; G06Q 40/04

(57) ABSTRACT

A computer-implemented method of mitigating the impact of carbon emissions from investment activity is disclosed. The method includes providing at least one computing device with a machine learning engine installed thereon, a database comprising a list of total carbon emissions for each company on a stock market, and a non-profit organization, to purchase carbon trading permits to offset the carbon cost of an AI-managed investment fund.

### NOTICE OF COPYRIGHTS AND TRADE DRESS

A portion of the disclosure of this patent document contains material which is subject to copyright or trade dress protection. This patent document may show and/or describe matter that is or may become trade dress of the owner. The copyright and trade dress owner has no objection to the facsimile reproduction by anyone of the patent disclosure, as it appears in the Patent and Trademark Office patent files or records, but otherwise reserves all copyright and trade dress rights whatsoever.

### CLAIM OF PRIORITY

This application does not claim priority to any patent or patent application.

### FIELD OF THE EMBODIMENTS

The present disclosure relates generally to a method for mitigating the impact of carbon emissions from artificial intelligence-directed investment activity. More particularly, the present disclosure relates to a method for mitigating the impact of carbon emissions from investment activity, where the investment activity is directed by a machine learning engine by purchasing carbon emissions permits through a non-profit organization.

### BACKGROUND

Actively managed funds as a group have largely failed to achieve their goals of beating the growth of the market as a whole. Further, actively managed funds are regularly outperformed by their passively managed counterparts, especially when management costs are taken into account. As a result, the share of funds in actively managed funds has declined annually as consumers demand better performing alternatives.

Consumers have also become more conscious of environmental issues over time. The most prominent of modern environmental issues is that of global warming and climate change. First developed in the 1800s, the consideration of a warming Earth and changing weather patterns are of increased importance, due to increased emissions of greenhouse gases, most notably carbon dioxide. As weather patterns have become more extreme and the warming of the Earth has become more measurable, many consumers and many governmental bodies have become increasingly concerned about the potential disaster that climate change and global warming may represent.

As a result, there are two, potentially competing, demands for the modern socially-conscious investor. The first is for better performing investment vehicles, which may entail greater business activity leading to greater environmental destruction and climate change/global warming. The second is for environmentally conscious methods of investment, which allow for environmentally sustainable growth, but may come at the cost of financial return. Therefore, a product that can unite these competing demands would be of great interest to such investors.

### SUMMARY OF THE INVENTION

The present disclosure provides for a computer-implemented method of mitigating the impact of carbon emissions from investment activity, including a step of providing at least one computing device, the at least one computing device preferably having a machine learning engine installed thereon, the machine learning engine preferably trained to analyze stock market data and identify target companies for inclusion in an investment portfolio. In an embodiment, the method includes a step of providing a database comprising a list of total carbon emissions for each company on a stock market. In an embodiment, the method includes a step of providing a non-profit organization, the non-profit organization preferably organized such that it is exempt from at least some portion of taxes normally charged by a government. In an embodiment, the method includes a step of determining, using the at least one computing device and the machine learning engine, the investment portfolio, the portfolio preferably including a number of publicly traded shares of each company in a set of companies on the stock market, the determining preferably based on an analysis of stock market data and an identification of target companies for inclusion in the investment portfolio. In an embodiment, the method includes a step of packaging the portfolio previously determined into a fund. In an embodiment, the method includes a step of identifying, using the database of carbon emissions, a carbon cost for the number of publicly traded shares of each company in the set of companies on the stock market. In an embodiment, the method includes a step of purchasing, using the non-profit organization, one or more carbon trading permits from one or more cap-and-trade compliance markets, preferably where the total carbon emissions represented by the one or more carbon trading permits is sufficient to offset the carbon cost previously identified.

In an embodiment, the method includes a step of removing, using the non-profit organization, the one or more carbon trading permits from the cap-and-trade compliance markets.

In an embodiment, the method includes a step of exchanging, using the non-profit organization, the one or more carbon trading permits to fund the purchase of one or more of: sequestration of atmospheric carbon, offset of atmospheric carbon, or removal of atmospheric carbon.

In an embodiment, the method includes a step of exchanging, using the non-profit organization, the one or more carbon trading permits to fund investment in one or more companies developing carbon removal technologies.

In an embodiment, the machine learning engine includes the use of ensemble methods.

In an embodiment, the analysis of stock market data includes analysis of actively managed funds.

In an embodiment, the identification of target companies for inclusion in an investment portfolio includes identification of one or more highest consensus publicly traded shares within the actively managed funds.

In an embodiment, the identification of target companies for inclusion in an investment portfolio includes identification of one or more highest performing publicly traded shares within the actively managed funds.

In an embodiment, the identification of target companies for inclusion in an investment portfolio includes identification of high performing large market capitalization stocks.

In an embodiment, the packaging includes acquiring the number of publicly traded shares of each company in the set of companies on the stock market previously determined.

In an embodiment, the fund is an exchange traded fund (ETF), mutual fund, co-mingled portfolio, or individually-managed portfolio.

In an embodiment, the fund is an actively managed fund managed by the at least one computing device and the machine learning engine.

In an embodiment, the one or more cap-and-trade compliance markets are North American cap-and-trade compliance markets.

In an embodiment, the one or more cap-and-trade compliance markets includes one or more of the Regional Greenhouse Gas Initiative and the California Air Resources Board cap-and-trade market.

### DETAILED DESCRIPTION OF THE PREFERRED EMBODIMENTS

Reference will now be made in detail to each embodiment of the present invention. Such embodiments are provided by way of explanation of the present invention, which is not intended to be limited thereto in any manner whatsoever. In fact, those of ordinary skill in the art may appreciate upon reading the present specification and viewing the present drawings that various modifications and variations can be made thereto.

For purposes of the present disclosure of the invention, unless specifically disclaimed, the singular includes the plural and vice-versa, the words “and” and “or” shall be both conjunctive and disjunctive, the words “any” and “all” shall both mean “any and all.”

An embodiment of the present invention provides a computer-implemented method of mitigating the impact of carbon emissions from investment activity, the method including the step of providing at least one computing device, the at least one computing device having a machine learning engine installed thereon. Preferably, the machine learning engine is trained to analyze stock market data, more preferably where the analysis of stock market data is analysis of actively managed funds. However, in some embodiments, general stock market data, and passively managed funds may also be analyzed.

Preferably, the machine learning engine is trained to identify target companies for inclusion in an investment portfolio, more preferably where the identification includes identification of one or more of the highest consensus publicly traded shares. Such identification may include using the machine learning engine to predict which publicly traded shares are seen to have the highest confidence level, or have or will have the highest financial return on investment. In some embodiments, the machine learning engine is trained to identify high conviction publicly traded shares from one or more actively managed funds. In some embodiments, the machine learning engine is trained to identify overweight positions in publicly traded shares from one or more actively managed funds. In an exemplary embodiment, the identification of target companies of inclusion in an investment portfolio includes identification of high performing large market capitalization stocks, preferably blue chip stocks.

In some embodiments, the computing device is a server, or cluster of servers. In some embodiments, the computing device is a cloud hosting or computing service. In some embodiments, the computing device is any hosting or computing solution known in the art appropriate for running a machine learning engine. In some embodiments, the machine learning engine uses one or more predictive engines or models to analyze stock market data or identify target companies for inclusion in an investment portfolio. In some embodiments, the machine learning engine uses ensemble methods to develop a consensus of multiple predictive engines or models. In such embodiments, the ensemble methods may include one or more of: bayes optimal classifier, bootstrap aggregating, random forest models, Bayesian model averaging, Bayesian model combination, bucket of models, stacking, or boosting. In some embodiments, the machine learning engine may use one or more models of supervised learning.

In an embodiment, the method of the present invention includes a step of providing a database which includes a list of total carbon emissions for each company on one or more stock markets. In some embodiments, such stock markets include any or all North American stock markets, South American stock markets, Asian stock markets, European stock markets, Australian stock markets, or African stock markets. An exemplary but non-limiting list of stock exchanges of the present invention includes the New York Stock Exchange, Nasdaq, the Shanghai Stock Exchange, Euronext, the Japan Exchange Group, the Hong Kong Stock Exchange, the Shenzhen Stock Exchange, the London Stock Exchange, the Bombay Stock Exchange, the Toronto Stock Exchange, and others. It is understood by persons of ordinary skill in the art that any stock exchange or market may be used in combination with the present invention. It will be further understood by persons of ordinary skill in the art that the stock exchange is not limited to a single stock exchange, but may be any combination of stock exchanges.

In some embodiments, total carbon emissions is not limited to carbon containing compounds and includes total greenhouse gas emissions. In some embodiments, total carbon emissions includes carbon dioxide (CO₂) emissions, methane (CH₄) emissions, nitrous oxide (N₂O) emissions, hydrofluorocarbon (HFC) emissions, perfluorocarbon (PFC) emissions, sulfur hexafluoride (SF₆) emissions, and nitrogen trifluoride (NF₃) emissions. Where multiple types of greenhouse gas emissions are tracked, total carbon emissions may be calculated by normalizing across different types of greenhouse gases by using carbon dioxide equivalents (CO₂e), where the CO₂e for a given greenhouse gas is equal to the amount of CO₂ emissions which would have the same global warming impact. In some embodiments, total carbon emissions includes total greenhouse gas emissions directly emitted by a given company. However, in some embodiments, total carbon emissions includes not only direct emissions, but includes approximations of the impact of a given company's supply chain and downstream greenhouse gas emissions impact, where downstream greenhouse gas impact may include emissions from use of products, emissions from disposal of products, emissions from transportation of products, or other sources of post-sales emissions.

In an embodiment, the method of the present invention includes a step of providing a non-profit organization, preferably where the non-profit organization is organized such that it is exempt from at least some portion of taxes normally charged by a government. In some embodiments, the non-profit organization is a non-profit organization organized under 26 U.S.C. § 501(c)(3). In some embodiments, the non-profit organization is organized such that it is tax exempt at a federal, state, municipal, provincial, or any other applicable governmental level. In some embodiments, the non-profit organization is tax exempt at multiple governmental levels, in multiple domestic jurisdictions, or in multiple international jurisdictions, or some combination thereof.

In an embodiment, the method of the present invention includes a step of determining, using the at least one computing device and the machine learning engine, the contents of the investment portfolio, preferably where the portfolio includes a number of publicly traded shares, and more preferably where the publicly traded shares are publicly traded shares of each company in a set of companies on the stock market. In some embodiments, the determining is based on an analysis of stock market data and/or an identification of target companies for inclusion in the investment portfolio. In some embodiments, the determining may include using the at least one computing device and the machine learning engine to decide one or more of: companies and/or funds in the portfolio, trades to be made in the portfolio, percentage holdings of each individual investment in the portfolio, numbers of particular shares in the portfolio, and any other decision, that would be understood by a person of ordinary skill in the art, to be typically made by an active manager of a portfolio or fund of any size. In some embodiments, the portfolio contains only shares of publicly traded companies. However, in other embodiments, the portfolio may contain any kind of investment vehicle, including, but not limited to, bonds, liquid currency, shares of any other type of fund, shares of exchange traded funds (ETFs), mutual fund shares, cryptocurrency, and any others.

In an embodiment, the method of the present invention includes a step of packaging the investment portfolio into a fund. In some embodiments, the packaging includes acquiring the number of publicly traded shares of each company in the set of companies on the stock market in the investment portfolio as determined by the at least computing device and the machine learning engine. In some embodiments, the acquiring may include borrowing shares or other means, and is not limited to direct purchase. In some embodiments, the packaging may also include any of: any applicable registration and compliance with regulatory agencies, exchange listing, negotiating with authorized participants, offering for sale, and other appropriate steps that will be appreciated by a person of ordinary skill in the art. It will be understood by persons of ordinary skill in the art that although the term fund is used here, the present invention is not limited to embodiments requiring the use of a literal fund. Instead, any form of investment capable of complying with the form of the investment portfolio may be used. For example, in some embodiments, the fund is an exchange traded fund (ETF), a mutual fund, a co-mingled portfolio, or an individually-managed portfolio. In some embodiments, the fund is an actively managed fund, preferably where the fund is actively managed by the at least one computing device and the machine learning engine.

In an embodiment, the method of the present invention includes a step of identifying, using the database of carbon emissions, a carbon cost for the number of publicly traded shares of each company in the set of companies on the stock market in the packaged fund. Such carbon cost may be determined, in an exemplary embodiment, by dividing the number of shares in the fund by the total number of outstanding shares of the particular company to whom the shares belong in order to determine the percentage of the total holdings of the particular company represented by the shares in the fund, and then multiplying this percentage by the total carbon emissions created by the particular company. In such exemplary embodiment, such carbon cost calculation would be repeated for each holding and/or each company represented in the fund and preferably the individual carbon costs would be totaled to provide a total carbon cost for the investments in the fund.

In an embodiment, the method of the present invention includes a step of purchasing, using the non-profit organization, one or more carbon trading permits from one or more cap-and-trade compliance markets, preferably where the total carbon emissions represented by the one or more carbon trading permits is sufficient to offset the carbon cost for the investments in the fund. In some embodiments, the one or more carbon trading permits may include permits for the emissions of carbon dioxide, for carbon dioxide equivalents, or for any greenhouse gas. In some embodiments, the cap-and-trade compliance markets may be any markets, worldwide, where carbon emissions permits or greenhouse gas emissions permits are sold. In some embodiments, the cap-and-trade compliance markets include North American cap-and-trade compliance markets. In some embodiments, the cap-and-trade compliance markets may also include Chinese or European cap-and-trade compliance markets. In some embodiments, the cap-and-trade compliance markets include one or more of the Regional Greenhouse Gas Initiative and the California Air Resources Board cap-and-trade markets.

In an embodiment, the method of the present invention includes a step of removing, using the non-profit organization, the one or more carbon trading permits or greenhouse gas emissions permits from the cap-and-trade compliance markets. In some embodiments, the one or more carbon trading permits are sequestered such that the emissions represented by such carbon trading permits or greenhouse gas emissions permits are completely removed from any market. In such embodiments, such removal is meant to prevent the emissions represented by such carbon or greenhouse gas trading permits by removing the legal right to produce such emissions. In such embodiments, the carbon emissions/greenhouse gas emissions/global warming impact of the investment activity is thus mitigated by reducing total carbon/greenhouse gas emissions by an amount equivalent to the carbon cost of the investments as calculated. In some embodiments, such removal may be temporary, and in other embodiments, such removal may be permanent.

In an embodiment, the method of the present invention includes a step of exchanging, using the non-profit organization, the one or more carbon trading permits to fund the purchase of one or more of: sequestration of atmospheric carbon, offset of atmospheric carbon, or removal of atmospheric carbon. In such embodiments, the carbon emissions/greenhouse gas emissions/global warming impact of the investment activity is thus mitigated by reducing atmospheric carbon by an amount equivalent to the carbon cost of the investments as calculated. In some embodiments, purchase of sequestration of atmospheric carbon, offset of atmospheric carbon, or removal of atmospheric carbon is purchased from companies offering such sequestration, offset, or removal in connection with newly developed, “cutting-edge”, technologies. In some embodiments, this step includes verification of the sequestration of atmospheric carbon, offset of atmospheric carbon, or removal of atmospheric carbon after purchase.

It is understood that when an element is referred hereinabove as being “on” another element, it can be directly on the other element or intervening elements may be present therebetween. In contrast, when an element is referred to as being “directly on” another element, there are no intervening elements present.

Moreover, any components or materials can be formed from a same, structurally continuous piece or separately fabricated and connected.

It is further understood that, although ordinal terms, such as, “first,” “second,” and “third,” are used herein to describe various elements, components, regions, layers and/or sections, these elements, components, regions, layers and/or sections should not be limited by these terms. These terms are only used to distinguish one element, component, region, layer and/or section from another element, component, region, layer and/or section. Thus, a “first element,” “component,” “region,” “layer” and/or “section” discussed below could be termed a second element, component, region, layer and/or section without departing from the teachings herein.

Features illustrated or described as part of one embodiment can be used with another embodiment and such variations come within the scope of the appended claims and their equivalents.

Spatially relative terms, such as “beneath,” “below,” “lower,” “above,” “upper” and the like, are used herein for ease of description to describe one element or feature's relationship to another element(s) or feature(s) as illustrated in the figures. It is understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly.

Example embodiments are described herein with reference to cross section illustrations that are schematic illustrations of idealized embodiments. As such, variations from the shapes of the illustrations, for example, of manufacturing techniques and/or tolerances, are to be expected. Thus, example embodiments described herein should not be construed as limited to the particular shapes of regions as illustrated herein, but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose the invention, including the best mode, and also to enable any person skilled in the art to practice the invention, including making and using any devices or systems and performing any incorporated methods. The patentable scope of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

In conclusion, herein is presented a computer-implemented method of mitigating the impact of carbon emissions from investment activity. The disclosure is illustrated throughout the written description. It should be understood that numerous variations are possible while adhering to the inventive concept. Such variations are contemplated as being a part of the present disclosure.

What is claimed is:

1. A computer-implemented method of mitigating the impact of carbon emissions from investment activity, comprising the steps of:
(a) providing at least one computing device, the at least one computing device having a machine learning engine installed thereon, the machine learning engine trained to analyze stock market data and identify target companies for inclusion in an investment portfolio;
(b) providing a database comprising a list of total carbon emissions for each company on a stock market;
(c) providing a non-profit organization, the non-profit organization organized such that it is exempt from at least some portion of taxes normally charged by a government;
(d) determining, using the at least one computing device and the machine learning engine, the investment portfolio, the portfolio comprising a number of publicly traded shares of each company in a set of companies on the stock market, the determining based on an analysis of stock market data and an identification of target companies for inclusion in the investment portfolio;
(e) packaging the portfolio determined in step (d) into a fund;
(f) identifying, using the database of carbon emissions, a carbon cost for the number of publicly traded shares of each company in the set of companies on the stock market determined in step (d);
(g) purchasing, using the non-profit organization, one or more carbon trading permits from one or more cap-and-trade compliance markets, where the total carbon emissions represented by the one or more carbon trading permits is sufficient to offset the carbon cost identified in step (f).

2. The method of claim 1, further comprising step (h) removing, using the non-profit organization, the one or more carbon trading permits from the cap-and-trade compliance markets.

3. The method of claim 1, further comprising step (h) exchanging, using the non-profit organization, the one or more carbon trading permits to fund the purchase of one or more of: sequestration of atmospheric carbon, offset of atmospheric carbon, or removal of atmospheric carbon.

4. The method of claim 1, further comprising step (h) exchanging, using the non-profit organization, the one or more carbon trading permits to fund investment in one or more companies developing carbon removal technologies.

5. The method of claim 1, wherein the machine learning engine comprises the use of ensemble methods.

6. The method of claim 1, wherein the analysis of stock market data comprises analysis of actively managed funds.

7. The method of claim 6, wherein the identification of target companies for inclusion in an investment portfolio comprises identification of one or more highest consensus publicly traded shares within the actively managed funds.

8. The method of claim 6, wherein the identification of target companies for inclusion in an investment portfolio comprises identification of one or more highest performing publicly traded shares within the actively managed funds.

9. The method of claim 6, wherein the identification of target companies for inclusion in an investment portfolio comprises identification of high performing large market capitalization stocks.

10. The method of claim 1, wherein the packaging comprises acquiring the number of publicly traded shares of each company in the set of companies on the stock market determined in step (d).

11. The method of claim 1, wherein the fund is an exchange traded fund (ETF), mutual fund, co-mingled portfolio, or individually-managed portfolio.

12. The method of claim 1, wherein the fund is an actively managed fund managed by the at least one computing device and the machine learning engine.

13. The method of claim 1, wherein the one or more cap-and-trade compliance markets are North American cap-and-trade compliance markets.

14. The method of claim 1, wherein the one or more cap-and-trade compliance markets comprises one or more of the Regional Greenhouse Gas Initiative and the California Air Resources Board cap-and-trade market.
